(19) United States
(12) Patent Application Publication
(10) Pub. No.: US 2006/0196837 A1
(43) Pub. Date: Sep. 7, 2006

(54) Desk organizers

(76) Inventor: Tom H. Dao, Irvine, CA (US)

Correspondence Address: Tom H. Dao, 100 RETREAT, IRVINE, CA, 92603, US

(21) Appl. No.: 11/070,517

(22) Filed: Mar. 2, 2005

(51) Int. Cl. B42F 17/00

(52) U.S. Cl. 211/11; 211/126.1

(57) ABSTRACT

Desk organizers are generally discussed herein with specific discussions extended to desk organizers having at least one cup holder. The organizers are configured to hold or store office-related products, such as paper clips, thumbtacks, business cards, etc. The cup holder is configured to hold a cup, a soda can, a mug, a Styrofoam cup, etc. The cup holder may include interference wedges for wedging a cup within the cup holder and may include a toaster, which may be part of a stack of toasters or may be fixedly secured to the base of the cup holder.

Desk organizers are generally discussed herein with specific discussions extended to desk organizers comprising a cup holder.

### BACKGROUND

Desk organizers for organizing office related products are widely commercially available. In general, they comprise a base and one or more wall enclosures for holding office related products, such as paper clips, thumb tacks, Post-It® notes, pens, pencils, business cards, tapes, letters, etc. While most organizers are made from a rigid plastic or an acrylic material, higher-end organizers may be made from wood, metal, and even, at least in part, leather.

Often times, drinks are served or consumed in an office environment. These drinks, either served in a cup, in a mug, from a bottle or a can, are typically placed on a desk or a coaster positioned on the desk. Unfortunately, these drinks will occasionally get tipped over when reaching for the drinks or when not paying attention and accidentally knocking the drinks over.

Accordingly, there is a need for an organizer that not only provides typical organization functions but also serves as a cup holder for decreasing or even eliminating accidental cup tipping.

### SUMMARY

The present invention may be implemented by providing a desk organizer comprising a plurality of storage bins for storing office related products and a cup holder, the cup holder comprising a base and a wall structure comprising a height comprising a channel extending at least along a section of the height.

In another aspect of the present invention, there is provided a desk organizer comprising a storage bin for storing office-related products and a cup holder comprising a wall structure, the cup holder and the plurality of storage bins being integrally formed, and wherein a toaster is positioned within the cup holder.

In yet other aspects of the present invention, there is provided a method for organizing a desk comprising placing an office-related product in a bin of a desk organizer; placing a cup in a cup holder, which is part of the desk organizer; wherein the cup holder comprises a wall and a channel positioned thereon.

Other aspects and variations of the apparatus and method summarized above for the desk organizers are also contemplated and will be more fully understood when considered with respect to the following disclosure

### BRIEF DESCRIPTION OF THE DRAWINGS

These and other features and advantages of the present invention will become appreciated as the same become better understood with reference to the specification, claims and appended drawings wherein:

FIG. 1 is a semi-schematic perspective view of a desk organizer provided in accordance with aspects of the present invention comprising a cup holder;

FIG. 2 is a semi-schematic perspective view of an alternative desk organizer provided in accordance with aspects of the present invention comprising two cup holders;

FIG. 3 is a semi-schematic perspective view of yet another alternative desk organizer provided in accordance with aspects of the present invention;

FIG. 4 is a semi-schematic top view of a cup holder provided in accordance with aspects of the present invention comprising a plurality of interference wedges;

FIG. 5 is a semi-schematic top view of an alternative cup holder provided in accordance with aspects of the present invention comprising a spring loaded arm; and

FIG. 6 is a semi-schematic perspective view of a stack of toasters usable with the desk organizers of the present invention.

### DETAILED DESCRIPTION

The detailed description set forth below in connection with the appended drawings is intended as a description of the presently preferred embodiments of desk organizers provided in accordance with practice of the present invention and is not intended to represent the only forms in which the present invention may be constructed or utilized. The description sets forth the features and the steps for constructing and using the desk organizers of the present invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

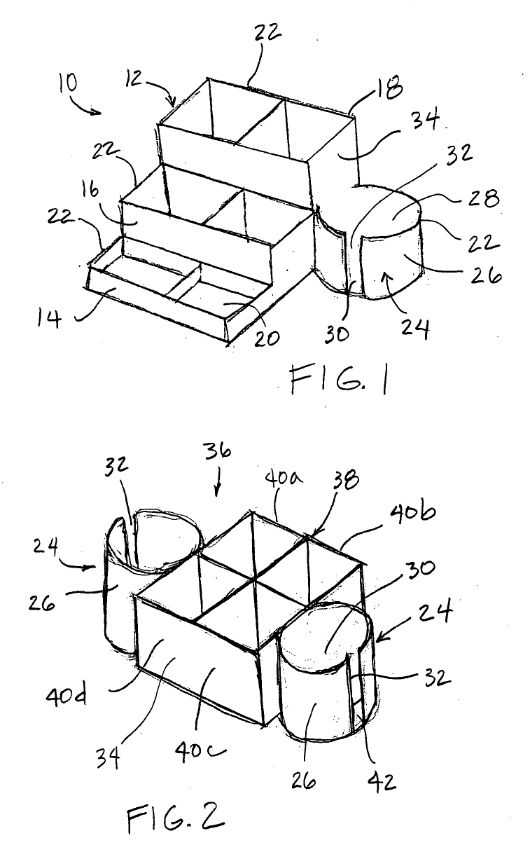

Referring now to FIG. 1, there is provided a semi-schematic perspective view of a first exemplary embodiment of a desk organizer provided in accordance with aspects of the present invention, which is generally designated 10. In one aspect of the present invention, the desk organizer 10 comprises a housing 12 comprising a plurality of storage bins 14, 16, 18 having a base 20, which in one exemplary embodiment is common to all the bins. Preferably, the storage bins have at least some varying heights as measured from the base 20 to the perimeter edge 22 of each respective bin. In the embodiment shown, six storage bins with three different heights are incorporated. However, there may be more than six bins with a same number of bin heights. Alternatively, there may be one or more bins up to and more than six bins. Still alternatively, the bins may have the same shaped configuration, such as the square or rectangular shape shown, or may comprise two or more shaped configurations, such as a square shape and a round shape, a square shape and an oval shape, or a rectangular shape, an oval shape, a round shape, and a complex shape, etc.

In one exemplary embodiment, a cup holder 24 comprising a wall structure 26 defining a cup storage cavity 28 and a base 30 is incorporated. In a preferred embodiment, the wall structure 26, and the base 30 are integrally formed with the organizer housing 12, including with the base 20 of the desk organizer 10. More preferably, the cup holder 24 and the housing 12 comprising the base 20 are integrally molded using a hard plastic material, such as an ABS material, polycarbonate, PEEK, SAN, ASA, an acrylic material, or similar materials. Obviously, other modern molding techniques may be used to form any of the desk organizers described elsewhere herein, such as over molding the organizer with different parts, and separately assembling two or more components together to form the organizer. The wall structure 26 preferably comprises a slot or a channel 32 for accommodating a handle of a mug or so-called coffee cup. The slot 32 preferably extends along the lengthwise or vertical height of the wall structure 26 in a direction generally perpendicular to the base 30. While the slot or channel 32 is shown extending the entire height of the wall structure 26, it may extend less than the entire height. In other words, a short wall structure (not shown) may extend from the base 30 and occupies part of the channel 32. In addition, the channel 32 may have non-parallel sides, such as a V-shape channel, a parabolic shape channel, or a complex shape channel.

As is readily apparent to a person of ordinary skill in the art, the cup holder is configured to accommodate a cup comprising a handle. However, the cup holder 24 may accommodate other cups or drinks, such as a standard cylindrical shaped cup, a soda can, a plastic cup, a Styrofoam cup, etc. In addition, the channel 32 may be positioned in a different location along the wall structure 26 than as shown. For example, assuming the channel 32 as shown is located at a zero angle position, the channel may instead be located at any angle greater than zero and excluding the angle adjoining the wall structure 34 of the housing 12. Preferably, the angle selected is such that placement of a cup comprising a handle into the cup holder 24 is facilitated and convenient, such as with consideration for a left handed user, a right handed user, or the angle of approach of the user in placing the cup.

Referring now to FIG. 2, a semi-schematic perspective view of a second exemplary embodiment of a desk organizer 36 provided in accordance with aspects of the present invention is shown. In one exemplary embodiment, the desk organizer 36 may be made from the same material as the organizer 10 shown in FIG. 1 and has two cup holders 24 positioned along two sides of a housing 38 comprising four storage bins 40a, 40b, 40c, 40d. In one exemplary embodiment, the four storage bins 40a-40c are similarly sized and shaped. However, the bins 40a-40c may have different sizes, shapes, and heights, and different numbers of bins, including 1 to 3 or greater than 4.

In one exemplary embodiment, the two cup holders 24 each comprises a channel 32 positioned 180 degrees from one another. However, the two channels may be similarly angularly aligned or aligned anywhere along the wall structure 26 excluding along the structure adjoining the wall 34 of the organizer housing 38. In one exemplary embodiment, at least one of the channels 32 of the two cup holders comprises a short wall structure 42 extending from the base 30 of the cup holder 24 and extends partially upwardly away from the base. In an alterative embodiment, at least one of the cup holders incorporate a continuous wall structure 26, i.e., no channel 32. This cup holder resembles a standard cylindrical organizer bin. However, standard cylindrical organizer bins in a multi-bin organizer are generally smaller in diameter than necessary to accommodate a cup, a soda can, or a mug. Accordingly, a channel-less cup holder incorporated with an organizer provided in accordance with aspects of the present invention are sized to accommodate a cup, a soda can, or a mug. If the mug has a handle, then the wall of the channel-less cup holder, at least right under the handle, is sufficiently short so as to come under the base of the handle.

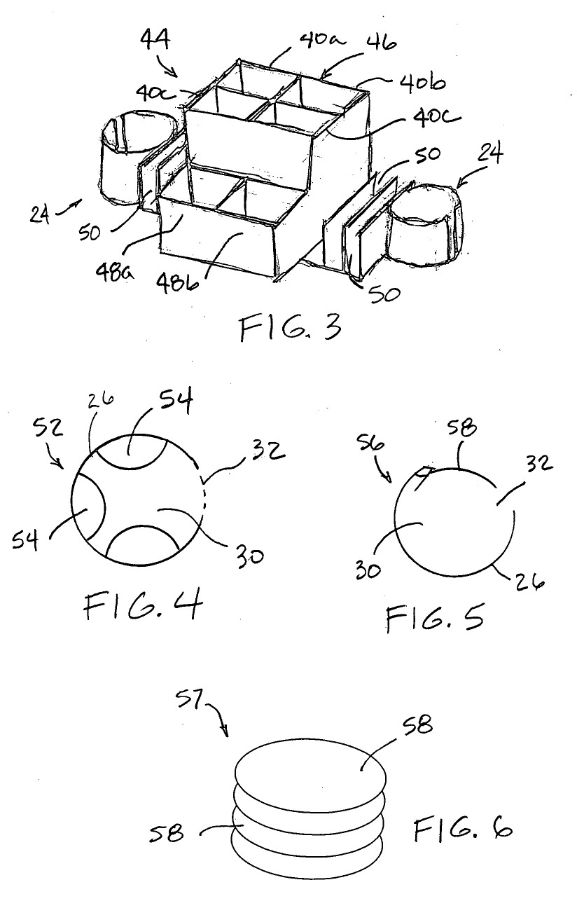

Referring now to FIG. 3, a semi-schematic perspective view of a third exemplary embodiment of a desk organizer 44 provided in accordance with aspects of the present invention is shown. In one exemplary embodiment, the desk organizer 44 may be made from the same material as the organizer 10 shown in FIG. 1 and has two cup holders 24 positioned along two sides of a housing 46 comprising six storage bins 40a-40d and 48a, 48b. Although the storage bins shown have two distinct heights having the same shaped opening, the bins may have different shapes, heights, and opening sizes, as previously discussed with reference to the organizers of FIGS. 1 and 2. Furthermore, although two cup holders 24 are shown, the organizer 44 may incorporate a single cup holder or more than two cup holders 24.

In the present embodiment, a plurality of card slots, mail slots, or letter slots 50 are incorporated for accommodating cards, mails, or letters. Assuming that the two sets of mail slots 50 are located on the left side and the right side of the housing 46 and the front side is the side closest to the viewer, the two cup holders are preferably situated to the left side and right side of the organizer 50. However, both cup holders or at least one of the cup holders may be situated on the front side of the organizer with a channel situated minus 90 to plus 90 degrees from the front, which is defined as the zero position or origin.

While a limited number of organizers are shown and discussed, a person of ordinary skill in the art can readily modify the organizers provided in accordance with aspects of the present invention to incorporate other commonly known organizer features. For example, a business card holder, a tape dispenser, a lid over a compartment, etc., may be incorporated. Accordingly, such modifications are contemplated within the spirit and scope of the present invention.

FIG. 4 is a semi-schematic top view of a cup holder 52 provided in accordance with aspects of the present invention. In one exemplary embodiment, the cup holder 52 comprises a wall structure 26, a base 30, a channel 32, and a plurality of pliant interference wedges 54. In a preferred embodiment, three wedges 54 are incorporated. However, one, two, or more than three wedges may be incorporated without deviating from the spirit and scope of the present invention. Interference wedges 54 used with cup holders are well known in the automobile art for pinning or wedging a cup within the cup holder for stability. In the present embodiment, the same wedges are incorporated with the cup holder 52. However, other interference devices may be incorporated for wedging a cup within a cup holder. For example, resilient springs and living hinges may be incorporated instead of resilient foam or rubber material. The cup holder 52 may be incorporated in any of the organizers shown and described elsewhere herein.

FIG. 5 is a semi-schematic top view of a cup holder 56 provided in accordance with aspects of the present invention. In one exemplary embodiment, the cup holder 56 comprises a wall structure 26, a base 30, a channel 32, and a spring loaded gate 58. Spring loaded gates used in cup holders are well known in the automobile industry. In the present embodiment, the same spring loaded gates are incorporated with the cup holder 56. The cup holder may be incorporated in any of the organizers shown and described elsewhere herein.

FIG. 6 is a semi-schematic view of a stack of toasters 57 comprising a plurality of individual toasters 58. The toasters 58 may be incorporated in any of the organizers shown and described elsewhere herein. For example, the plurality of toasters 58 may be placed in one or more similarly shaped bins in an organizer provided in accordance with aspects of the present invention. More preferably, the toasters are placed in one or more of the cup holders 24 described elsewhere herein. The toasters may be a foam type toaster, a rubber type toaster, a plastic type toaster, or any known commercially available prior art toasters, such as toasters made with corkscrew material. More preferably, the toasters are a rimless rubber type toaster adapted to fit inside a cup holder. In an exemplary embodiment, only a few toasters are stored in each cup holder with the balance of cup holder space reserved for a cup or a mug. Exemplary number of toasters include two to five. In another alternative embodiment, a toaster is permanently affixed to the base of a cup holder with optional additional toasters stacked on top thereof. In yet another alternative embodiment, a single toaster is placed in a cup holder.

In use, a cup may be placed on top of the stack of toasters 57. If a toaster is needed for a second cup, one can be taken from the stack and used for the second cup. However, if a second cup holder is incorporated in the organizer, the second cup may be placed in the second cup holder.

Although limited preferred embodiments and methods for making and using the desk organizers provided in accordance with aspects of the present invention have been specifically described and illustrated, many modifications and variations will be apparent to those skilled in the art. For example, various material changes may be used, incorporating different mechanical engagement means to attach the various components to one another, making use of two or more different materials, making the organizers transparent, adding color to the material, etc. Accordingly, it is to be understood that the desk organizers constructed according to principles of this invention may be embodied other than as specifically described herein. The invention is also defined in the following claims.

What is claimed is:

1. A desk organizer comprising a plurality of storage bins for storing office related products and a cup holder, the cup holder comprising a base and a wall structure extending away from the base comprising a height comprising a channel extending at least along a section of the height.

2. The desk organizer of claim 1, wherein the cup holder and the plurality of storage bins are integrally formed from a plastic material.

3. The desk organizer of claim 1, wherein the cup holder and the plurality of storage bins have a common base.

4. The desk organizer of claim 1, wherein the plurality of storage bins comprise at least three storage bins.

5. The desk organizer of claim 4, wherein the at least three storage bins have at least one arcuate shaped opening.

6. The desk organizer of claim 1, wherein the channel extends the entire height.

7. The desk organizer of claim 1, further comprising a toaster positioned inside the cup holder.

8. The desk organizer of claim 1, wherein the cup holder comprises a plurality of interference wedges.

9. A desk organizer comprising a storage bin for storing office-related products and a cup holder comprising a wall structure, the cup holder and the plurality of storage bins being integrally formed, and wherein a toaster is positioned within the cup holder.

10. The desk organizer of claim 9, wherein the cup holder comprises a channel.

11. The desk organizer of claim 9, wherein the cup holder comprises a plurality of wedges.

12. The desk organizer of claim 9, wherein the storage bin and the cup holder are integrally formed from a plastic material.

13. The desk organizer of claim 9, wherein the toaster is permanently affixed to a base of the cup holder.

14. The desk organizer of claim 9, wherein the toaster is made from a transparent material.

15. The desk organizer of claim 9, wherein the toaster is made from at least one of an opaque and a semi-opaque material.

16. A method for organizing a desk comprising:
placing an office-related product in a bin of a desk organizer;
placing a cup in a cup holder, which is part of the desk organizer;
wherein the cup holder comprises a wall extending away from a base and a channel for accommodating a handle.

17. The method of claim 16, further comprising placing a second-office related product in a second bin.

18. The method of claim 16, wherein the cup holder comprises a toaster.

19. The method of claim 16, wherein the bin and the cup holder are integrally formed.

20. The method of claim 16, wherein the bin has an arcuate shape opening.
